(19) United States
(12) Patent Application Publication
(10) Pub. No.: US 2010/0097631 A1
(43) Pub. Date: Apr. 22, 2010

(54) METHOD AND APPARATUS FOR AUTOMATICALLY RECONFIGURING A PRINT DRIVER FOR AN IMAGE PRODUCTION DEVICE

(75) Inventors: Matthew H. DeRoller, Webster, NY (US); David Ashton, Penfield, NY (US); Kirk Pothos, Webster, NY (US)

Correspondence Address: Prass LLP, 2661 Riva Road, Building 1000, Suite 1044, Annapolis, MD, 21401, US

(73) Assignee: XEROX CORPORATION, Norwalk, CT (US)

(21) Appl. No.: 12/255,095

(22) Filed: Oct. 21, 2008

(51) Int. Cl. G06F 3/12

(52) U.S. Cl. 358/1.15

(57) ABSTRACT

A method and apparatus for automatically reconfiguring a print driver for an image production device is disclosed. The method may include receiving a request to print a print job from a user, wherein the print job includes one or more print job parameters, determining if the one or more print job parameters violate one or more print policies, wherein if it is determined that the one or more print job parameters violate one or more print policies, notifying the user that the one or more print policies have been violated, prompting the user to select to have the print driver reconfigured to adhere to the one or more print policies that were violated, determining if the user selected to reconfigure the print driver, wherein if it is determined that the user selected to reconfigure the print driver, reconfiguring the print driver to adhere to the one or more print policies that were violated, and sending a signal to print the requested print job.

### BACKGROUND

Disclosed herein are a method and apparatus for automatically reconfiguring a print driver for an image production device.

In conventional network printing, each time a print job is submitted by a user, an output management process will determine, based upon defined print policies, if the target printer is the most appropriate printer to which the print job should be printed. In this process, the user is presented with a message, indicating the status of the particular print job. These messages are typically rejection or confirmation messages indicating why the print job was not processed (e.g. color printing not allowed, duplex required, etc) or confirming that the print job was processed.

If a print job is rejected for not adhering to print policy, the print job will not be printed until something is done to change the job stream so it adheres to print policy. One option is for the print driver settings to be manually changed to adhere to print policy (e.g. B&W is set by default, or Duplex (2-sided printing) is selected, etc.). However, this process requires the user to know how to access the print driver settings, and to know which options to change. Thus, the conventional process may lead to a user's dissatisfaction and frustration over repeatedly changing print driver settings based on print policies, or not being confident as to which options to change, for example.

### SUMMARY

A method and apparatus for automatically reconfiguring a print driver for an image production device is disclosed. The method may include receiving a request to print a print job from a user, wherein the print job includes one or more print job parameters, determining if the one or more print job parameters violate one or more print policies, wherein if it is determined that the one or more print job parameters violate one or more print policies, notifying the user that the one or more print policies have been violated, prompting the user to select to have the print driver reconfigured to adhere to the one or more print policies that were violated, determining if the user selected to reconfigure the print driver, wherein if it is determined that the user selected to reconfigure the print driver, reconfiguring the print driver to adhere to the one or more print policies that were violated, and sending a signal to print the requested print job.

### BRIEF DESCRIPTION OF THE DRAWINGS

FIG. 1 is an exemplary diagram of an image production environment in accordance with one possible embodiment of the disclosure;

FIG. 2 is an exemplary block diagram of an processing device in accordance with one possible embodiment of the disclosure;

FIG. 3 is a flowchart of an exemplary print driver reconfiguration process in accordance with one possible embodiment of the disclosure; and

FIG. 4 is a diagram illustrating an exemplary user dialogue box in accordance with one possible embodiment of the disclosure.

### DETAILED DESCRIPTION

Aspects of the embodiments disclosed herein relate to a method and apparatus for automatically reconfiguring a print driver for an image production device.

The disclosed embodiments may include a method for automatically reconfiguring a print driver for an image production device. The method may include receiving a request to print a print job from a user, wherein the print job includes one or more print job parameters, determining if the one or more print job parameters violate one or more print policies, wherein if it is determined that the one or more print job parameters violate one or more print policies, notifying the user that the one or more print policies have been violated, prompting the user to select to have the print driver reconfigured to adhere to the one or more print policies that were violated, determining if the user selected to reconfigure the print driver, wherein if it is determined that the user selected to reconfigure the print driver, reconfiguring the print driver to adhere to the one or more print policies that were violated, and sending a signal to print the requested print job.

The disclosed embodiments may further include a processing device that may include a print policy database that stores print policies for one or more image production devices, and a print driver reconfiguration unit that receives a request to print a print job from a user, wherein the print job includes one or more print job parameters, determines if the one or more print job parameters violate one or more print policies stored in the print policy database, wherein if the print driver reconfiguration unit determines that the one or more print job parameters violate one or more print policies, the print driver reconfiguration unit notifies the user that the one or more print policies have been violated, prompts the user to select to have the print driver reconfigured to adhere to the one or more print policies that were violated, determines if the user selected to reconfigure the print driver, wherein if the print driver reconfiguration unit determines that the user selected to reconfigure the print driver, the print driver reconfiguration unit reconfigures the print driver to adhere to the one or more print policies that were violated, and sends a signal to print the requested print job.

The disclosed embodiments may further include computer-readable medium storing instructions for controlling a computing device for automatically reconfiguring a print driver for an image production device. The instructions may include receiving a request to print a print job from a user, wherein the print job includes one or more print job parameters, determining if the one or more print job parameters violate one or more print policies, wherein if it is determined that the one or more print job parameters violate one or more print policies, notifying the user that the one or more print policies have been violated, prompting the user to select to have the print driver reconfigured to adhere to the one or more print policies that were violated, determining if the user selected to reconfigure the print driver, wherein if it is determined that the user selected to reconfigure the print driver, reconfiguring the print driver to adhere to the one or more print policies that were violated, and sending a signal to print the requested print job.

Print policies are rules for printing that dictate parameters by which a user may print his or her print jobs. For example, a print policy may include which image production device in a network may be used for the type of print job (e.g., duplex, color, number of pages, etc.), the mode the print job must be printed in (e.g., black-and-white, duplex, etc.), or other rules as set forth by an administrator, manufacturer, etc. Print policies may be stored a database in a memory on a processing device, such as a computer, print policy server (internal or external to an image production device), etc., for example.

A print driver is a program that acts as a translator between a software application and an image production device and may be stored in the memory of a processing device. The print driver enables an operating system of a processing device to properly build and format commands and data bound for a particular image production device. Each image production device as its own internal “language” with its own codes and commands. Software applications used by the processing device use print drivers to communicate with a variety of printers. In the some operating environments, print drivers are shared in order to eliminate the need for each application to have its own print driver. In effect, a print driver tells the operating system all it needs to know to successfully operate the particular image production device.

The disclosed embodiments may concern giving users the option of having a print driver for an image production device automatically reconfigured so future print jobs will not violate print policies. The process may include an interface that may present a user with a selectable option that if selected, reconfigures the print driver automatically so that it may adhere to print policies. These reconfigured settings may remain in effect for any print jobs submitted thereafter.

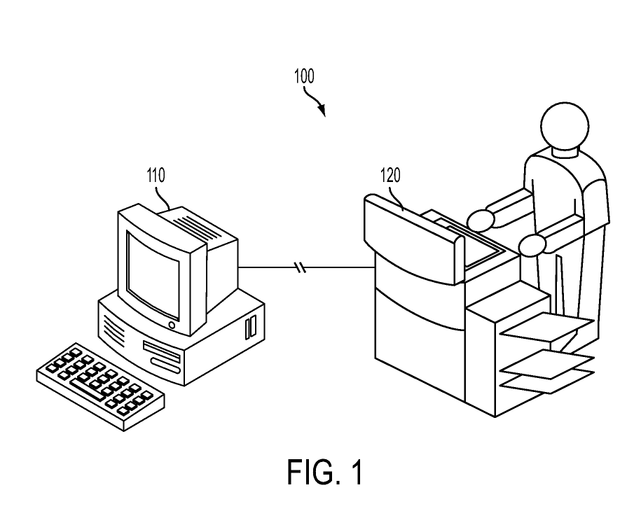

FIG. 1 is an exemplary diagram of an image production environment 100 in accordance with one possible embodiment of the disclosure. The image production environment 100 may include a processing device 110 that may be hardwired or Tirelessly connected to an image production device 120.

The processing device 110 may be any device that uses software applications and communicates with the image production device 120 to submit print jobs for processing, including a computer, a server, a telephone, or a personal digital assistant, for example. The image production device 120 may be any device that may be capable of printing documents, including a printer, a copier/printer, an office copier/printer, a high-capacity copier/printer, a commercial copier/printer, a facsimile/printer device, or a multi-function device, for example.

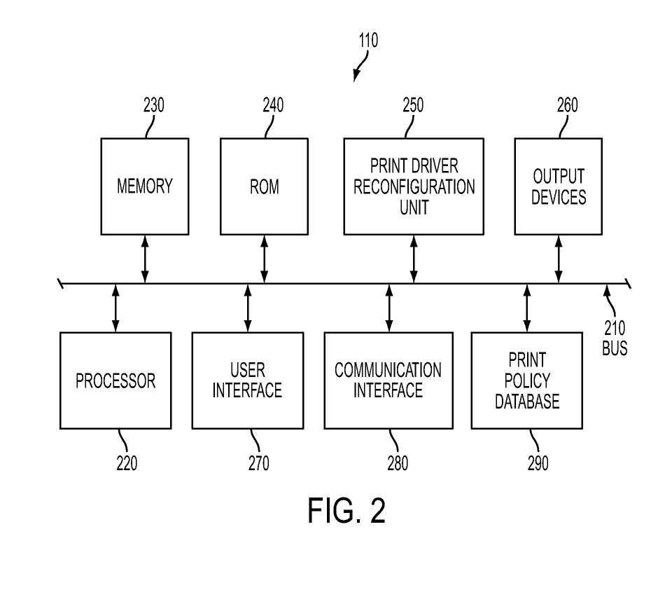

FIG. 2 is an exemplary block diagram of a processing device 110 in accordance with one possible embodiment of the disclosure. The processing device 110 may include a bus 210, a processor 220, a memory 230, a read only memory (ROM) 240, a print driver reconfiguration unit 250, output devices 260, a user interface 270, a communication interface 280, and a print policy database 290. Bus 210 may permit communication among the components of the processing device 110.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Communication interface 280 may include any mechanism that facilitates communication via a network. For example, communication interface 280 may include a modem. Alternatively, communication interface 280 may include other mechanisms for assisting in communications with other devices and/or systems.

ROM 240 may include a conventional ROM device or another type of static storage device that stores static information and instructions for processor 220. A storage device may augment the ROM and may include any type of storage media, such as, for example, magnetic or optical recording media and its corresponding drive.

User interface 270 may include one or more conventional mechanisms that permit a user to input information to and interact with the image production unit 100, such as a keyboard, a display, a mouse, a pen, a voice recognition device, touchpad, buttons, etc., for example. Output devices 260 may include one or more conventional mechanisms that output information to the user, including a display, a printer, one or more speakers, or a medium, such as a memory, or a magnetic or optical disk and a corresponding disk drive, for example.

The print policy database 290 may be any database stored on any internal or external memory device, such as the memory 230, that may include print polices for one or more image production devices 120. The print policies may include limitations or rules concerning one or more print job parameters, that may include at least one of the particular printer being requested, the size of paper required by the print job, the number of pages required by the print job, whether color is required for the print job, whether duplex mode is required for the print job, or the type of finishing required by the print job. The memory 230 may also serve to store one or more print drivers used by the processing device 110 to communicate and process print jobs for print using image production devices 120.

The automatic print driver reconfiguration process in the disclosed embodiments concerns checking the print parameters of a user's print job against the print policies stored in the print policy database 290. For example, a user may request a large print job over a certain number of pages to be printed at a particular printer “X”. However, print policies stored in the print policy database 290 may dictate that print jobs over a certain number of pages be printed on another printer or be printed in duplex. Therefore, according to the disclosed embodiments, the user will be notified that the print job parameters violate one or more print policies. The user may then be given the option to reconfigure the print driver default settings in order for the print job parameters to adhere to print policies.

The processing device 110 may perform such functions in response to processor 220 by executing sequences of instructions contained in a computer-readable medium, such as, for example, memory 230. Such instructions may be read into memory 230 from another computer-readable medium, such as a storage device or from a separate device via communication interface 280.

The processing device 110 illustrated in FIGS. 1-2 and the related discussion are intended to provide a brief, general description of a suitable communication and processing environment in which the disclosure may be implemented. Although not required, the disclosure will be described, at least in part, in the general context of computer-executable instructions, such as program modules, being executed by the processing device 110, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the disclosure may be practiced in communication network environments with many types of communication equipment and computer system configurations, including personal computers, hand-held devices, multi-processor systems, microprocessor-based or programmable consumer electronics, and the like.

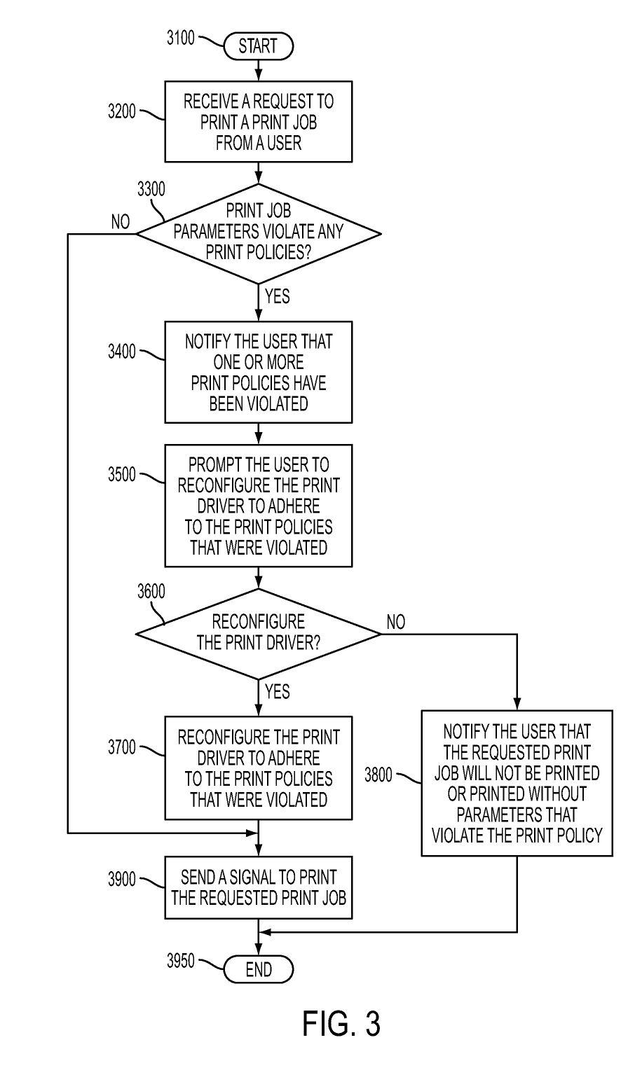

For illustrative purposes, the operation of the print driver reconfiguration unit 250 and the exemplary print driver reconfiguration process are described in FIG. 3 in relation to the diagrams shown in FIGS. 1-2.

FIG. 3 is a flowchart of an exemplary print driver reconfiguration process in accordance with one possible embodiment of the disclosure. The process may begin at step 3100, and continues to step 3200 where the print driver reconfiguration unit 250 may receive a request to print a print job from a user. The print job may include one or more print job parameters, such as the particular image production device 120 being requested, the size of paper required by the print job, the number of pages required by the print job, whether color is required for the print job, whether duplex mode is required for the print job, or the type of finishing required by the print job, for example.

At step 3300, the print driver reconfiguration unit 250 may determine if one or more print job parameters violate one or more print policies retrieved from the print policy database 290. If the print driver reconfiguration unit 250 determines that one or more print job parameters do not violate one or more print policies, the process may go to step 3950 and end.

If at step 3300, the print driver reconfiguration unit 250 determines that one or more print job parameters violate one or more print policies, then at step 3400, the print driver reconfiguration unit 250 may notify the user that one or more print policies have been violated. At step 3500, the print driver reconfiguration unit 250 may prompt the user to select to have the print driver reconfigured to adhere to the one or more print policies that were violated.

At step 3600, the print driver reconfiguration unit 250 may determine if the user selected to reconfigure the print driver. If the print driver reconfiguration unit 250 determines that the user selected to reconfigure the print driver, then at step 3800, the print driver reconfiguration unit 250 may notify the user that the requested print job will either not be printed or be printed without parameters that violate the print policy. The process may then go to step 3950, and end.

If at step 3600, the print driver reconfiguration unit 250 determines that the user selected to reconfigure the print driver, then at step 3700, the print driver reconfiguration unit 250 may reconfigure the print driver to adhere to the one or more print policies that were violated. The reconfigured print driver may be configured in a manner so that it is used for subsequent print jobs or just temporarily for one or more print jobs. The print driver reconfiguration unit 250 may also send a confirmation message to be displayed to the user indicated that the print driver has been successfully reconfigured.

At step 3900, the print driver reconfiguration unit 250 may send a signal to print the requested print job. The signal may be sent to the image production device 120, for example. The process may then go to step 3950, and end.

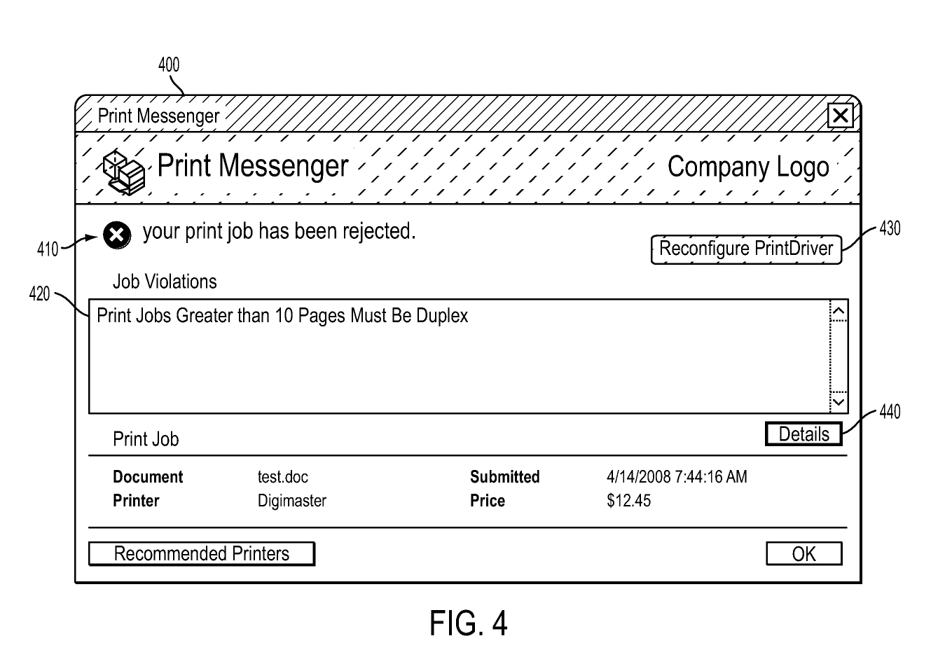

FIG. 4 is a diagram illustrating an exemplary user dialogue box 400 in accordance with one possible embodiment of the disclosure. The exemplary user dialogue box 400 may include a message concerning the requested print job 410, a list of print policy violations 420, a button to select print driver reconfiguration 430, and a button 440 to receive more details concerning the print policy violation.

The message 410 may be a rejection message, a print confirmation message, caution message, etc. The list of print policy violations 420 may be provided in any manner known to one of skill in the art, such as in a list, for example. The button to select reconfiguration 430 may be selected via an enter button on a keyboard, a mouse click, etc. Clicking the print driver reconfiguration button 430 may result in the reconfiguration being performed immediately, or in the appearance of a confirmation dialogue box asking the user to confirm the selection. If there is more than one print policy violation listed, the print driver may be reconfigured regarding all of the print policy violations or just selected ones of the print policy violations.

The details button 440 may enable the user to receive more detailed information concerning all of the print policy violations or just selected ones of the print policy violations. The details button 440 may also provide details concerning other aspects of the print job.

Note that the user dialogue box 400 shown in FIG. 4 is only an example. The user dialogue box 400 and its components may be arranged and presented in any manner known to one of skill in the art.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein. It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for automatically reconfiguring a print driver for an image production device, comprising:
receiving a request to print a print job from a user, wherein the print job includes one or more print job parameters;
determining if the one or more print job parameters violate one or more print policies, wherein if it is determined that the one or more print job parameters violate one or more print policies,
notifying the user that the one or more print policies have been violated;
prompting the user to select to have the print driver reconfigured to adhere to the one or more print policies that were violated;
determining if the user selected to reconfigure the print driver, wherein if it is determined that the user selected to reconfigure the print driver,
reconfiguring the print driver to adhere to the one or more print policies that were violated; and
sending a signal to print the requested print job.

2. The method of claim 1, wherein if it is determined that the user did not select to reconfigure the print driver,
notifying the user that the requested print job will one of not be printed and printed without parameters that violate the print policy.

3. The method of claim 1, wherein the reconfigured print driver is used for subsequent print jobs.

4. The method of claim 1, wherein the one or more print job parameters includes at least one of the particular an image production device being requested, the size of paper required by the print job, a number of pages required by the print job, whether color is required for the print job, whether duplex mode is required for the print job, and a type of finishing required by the print job.

5. The method of claim 1, further comprising:
retrieving print policies from a print policy database; and
determining if one or more print polices have been violated based on the retrieved print policies.

6. The method of claim 1, further comprising:
sending a confirmation message to be displayed to the user that the print driver has been successfully reconfigured.

7. The method of claim 1, wherein the image production device is one of a printer, a copier/printer, an office copier/printer, a high-capacity copier/printer, a commercial copier/printer, a facsimile/printer device, and a multi-function device.

8. A processing device that automatically reconfigures a print driver for an image production device, comprising:
a print policy database that stores pint policies for one or more image production devices; and
a print driver reconfiguration unit that receives a request to print a print job from a user, wherein the print job includes one or more print job parameters, determines if one or more print job parameters violate one or more print policies stored in the print policy database, wherein if the print driver reconfiguration unit determines that one or more print job parameters violate one or more print policies, the print driver reconfiguration unit notifies the user that one or more print policies have been violated, prompts the user to select to have the print driver reconfigured to adhere to the one or more print policies that were violated, determines if the user selected to reconfigure the print driver, wherein if the print driver reconfiguration unit determines that the user selected to reconfigure the print driver, the print driver reconfiguration unit reconfigures the print driver to adhere to the one or more print policies that were violated, and sends a signal to print the requested print job.

9. The processing device of claim 8, wherein if it is determined that the user did not select to reconfigure the print driver, the print driver reconfiguration unit notifies the user that the requested print job will one of not be printed and printed without parameters that violate the print policy.

10. The processing device of claim 8, wherein the reconfigured print driver is used for subsequent print jobs.

11. The processing device of claim 8, wherein the one or more print job parameters includes at least one of the particular an image production device being requested, the size of paper required by the print job, a number of pages required by the print job, whether color is required for the print job, whether duplex mode is required for the print job, and a type of finishing required by the print job.

12. The processing device of claim 8, wherein the print driver reconfiguration unit retrieves print policies from a print policy database, and determines if one or more print polices have been violated based on the retrieved print policies.

13. The processing device of claim 8, wherein the print driver reconfiguration unit sends a confirmation message to be displayed to the user that the print driver has been successfully reconfigured.

14. The processing device of claim 8, wherein the image production device is one of a printer, a copier/printer, an office copier/printer, a high-capacity copier/printer, a commercial copier/printer, a facsimile/printer device, and a multi-function device.

15. A computer-readable medium storing instructions for controlling a computing device for automatically reconfiguring a print driver for an image production device, the instructions comprising:
receiving a request to print a print job from a user, wherein the print job includes one or more print job parameters;
determining if the one or more print job parameters violate one or more print policies, wherein if it is determined that the one or more print job parameters violate one or more print policies,
notifying the user that the one or more print policies have been violated;
prompting the user to select to have the print driver reconfigured to adhere to the one or more print policies that were violated;
determining if the user selected to reconfigure the print driver, wherein if it is determined that the user selected to reconfigure the print driver,
reconfiguring the print driver to adhere to the one or more print policies that were violated; and
sending a signal to print the requested print job.

16. The computer-readable medium of claim 15, wherein if it is determined that the user did not select to reconfigure the print driver,
notifying the user that the requested print job will one of not be printed and printed without parameters that violate the print policy.

17. The computer-readable medium of claim 15, wherein the reconfigured print driver is used for subsequent print jobs.

18. The computer-readable medium of claim 15, wherein the one or more print job parameters includes at least one of the particular an image production device being requested, a size of paper required by the print job, the number of pages required by the print job, whether color is required for the print job, whether duplex mode is required for the print job, and a type of finishing required by the print job.

19. The computer-readable medium of claim 15, further comprising:
retrieving print policies from a print policy database; and
determining if one or more print polices have been violated based on the retrieved print policies.

20. The computer-readable medium of claim 15, further comprising:
sending a confirmation message to be displayed to the user that the print driver has been successfully reconfigured.

21. The computer-readable medium of claim 15, wherein the image production device is one of a printer, a copier/printer, an office copier/printer, a high-capacity copier/printer, a commercial copier/printer, a facsimile/printer device, and a multi-function device.
